(19) United States
(12) Patent Application Publication
(10) Pub. No.: US 2018/0097921 A1
(43) Pub. Date: Apr. 5, 2018

(54) METHOD, ELECTRONIC DEVICE, COMPUTER WITH NON-VOLATILE READABLE STROAGE FOR INPUTTING VOICE OF PHONE SET TO SMART DEVICE

(71) Applicant: ASKEY COMPUTER CORP., New Taipei City (TW)

(72) Inventor: Jonathan Sau-Ching WAN, New Taipei City (TW)

(21) Appl. No.: 15/281,755

(22) Filed: Sep. 30, 2016

(51) Int. Cl. H04M 1/27

(52) U.S. Cl. CPC H04M 1/271; H04M 2201/39; H04M 2250/74

(57) ABSTRACT

A method of inputting the voice of a phone set into a smart device comprises: emulating a voice input unit for the smart device by an electronic device; receiving a phone voice signal from the phone set through a RJ-11 connector and a SLIC circuitry of the electronic device; processing the phone voice signal to generate a PCM voice data for the smart device by a processing unit of the electronic device; and sending the PCM voice data to the smart device to emulate an input action from the emulated voice input unit to the smart device by a communication unit of the electronic device.

### BACKGROUND

### Technical Field

The invention relates to voice input for smart device.

### Related Art

Nowadays, a smart phone is widely used not only as a telecommunications device but also a voice input unit for speech recognition or voice command. It behaves like a smart machine, and it can perform Internet applications such as getting flight information, weather report or wake up call. Besides, the voice input of the smart phone is also used for voice-to-text transcription, speech recognition or translation system. When operating, a smart phone user carries the phone on hand, press a button and speak to it. If the user is moving or out of home or office, it is convenient to use these applications or functions on the smart phone which the user is almost carrying with himself.

However, if the user is at home and places his smart phone at a corner to charge it, it is sometimes difficult to find the phone and cumbersome and for the user to take his/her phone and press the keys to perform these applications or functions. Moreover, it is dangerous to hold the smart phone to answer a phone call when the smart phone is being charged.

There are lots of other voice input units such as Bluetooth headset, Bluetooth audio speaker with MIC, Bluetooth phone. They can used to send voice command and voice call. However, the first problem is high cost compared with phone set. And they are not as wildly available as touch tone phone set. Then they are not as easy as picking up the handset and start speaking. On most Bluetooth speakers, headset devices, a user still have to find the device and location where and what button to push to talk. If it is speaker, there is no privacy or a way not to disturb other people in the room.

### SUMMARY

An aspect of the disclosure is to provide a method, an electronic device and a computer with non-volatile readable storage to use a phone set or also called touch tone phone for inputting a voice of a phone set to a smart device.

In one embodiment, a method of inputting the voice of a phone set into a smart device comprises: emulating a voice input unit for the smart device by an electronic device; receiving a phone voice signal from the phone set through a RJ-11 connector and a SLIC circuitry of the electronic device; processing the phone voice signal to generate a PCM voice data for the smart device by a processing unit of the electronic device; and sending the PCM voice data to the smart device to emulate an input action from the emulated voice input unit to the smart device by a communication unit of the electronic device.

In one embodiment, the method further comprises: establishing a connection between the smart device and the electronic device by the communication unit.

In one embodiment, the connection is Bluetooth connection, and the emulated voice input unit is a Bluetooth MIC which performs the same function with the default MIC of the smart device.

In one embodiment, the method further comprises detecting whether a phone set is picked up through the RJ-11 connector and the SLIC circuitry by the processing unit.

In one embodiment, the method further comprises analyzing the PCM voice data as a voice command for controlling the smart device by the smart device.

In one embodiment, the method further comprises performing a speech recognition on the PCM voice data by the smart device.

In one embodiment, the method further comprises detecting which button of the phone set is pressed; converting the pressed button into digital code emulating the user pressing a keyboard; and executing a designate task according to the result of detecting the pressed button (digital code).

In one embodiment, the phone voice signal is converted from analog to digital by the SLIC circuitry and the processing unit to generate the PCM voice data, and the PCM voice data is sent to the smart device without additional voice analyzation and voice recognition performed by the processing unit.

In one embodiment, an electronic device adapted for a phone set and a smart device comprises a communication unit, an interface for the phone set, and a processing unit. The communication unit is configured to emulate a voice input unit for the smart device. The interface for the phone set comprises a RJ-11 connector and a SLIC circuitry configured to receive a phone voice signal from the phone set. The processing unit is configured to process the phone voice signal to generate a PCM voice data for the smart device. The communication unit is configured to send the PCM voice data to the smart device to emulate an input action from the emulated voice input unit to the smart device.

In one embodiment, the electronic device is a PCB, a chip, VoIP router, a cable modem, an OTT box or a set top box.

In one embodiment, the communication unit is configured to establish a connection between the smart device and the electronic device.

In one embodiment, the connection is Bluetooth connection, and the emulated voice input unit is a Bluetooth MIC which performs the same function with the default MIC of the smart device.

In one embodiment, the processing unit is configured to detect whether a phone set is picked up through the RJ-11 connector and the SLIC circuitry.

In one embodiment, the connection is Bluetooth connection, and the emulated voice input unit is a Bluetooth MIC which performs the same function with the original MIC of the smart device.

In one embodiment, the phone voice signal is converted from analog to digital by the SLIC circuitry and the processing unit to generate the PCM voice data, and the PCM voice data is sent to the smart device without additional voice analyzation and voice recognition performed by the processing unit.

In one embodiment, the PCM voice data is sent to the smart device as a voice command for controlling the smart device.

In one embodiment, the PCM voice data is sent to the smart device for speech recognition.

In one embodiment, the PCM voice data includes information about the push-button dialing of the phone set for a designate task executed on the smart device.

In one embodiment, computer with non-volatile readable storage medium stores one or more programs, the one or more programs comprises instructions, which when executed by one or more processors of the computer, cause the computer to perform a method for a phone set and a smart device. The method comprises: emulating a voice input unit for the smart device; receiving a phone voice signal from the phone set through a RJ-11 connector and a SLIC circuitry; processing the phone voice signal to generate a PCM voice data for the smart device; and sending the PCM voice data to the smart device to emulate an input action from the emulated voice input unit to the smart device.

In one embodiment, the method further comprises: establishing a connection between the smart device and the electronic device.

In one embodiment, the connection is Bluetooth connection, and the emulated voice input unit is a Bluetooth MIC which performs the same function with the default MIC of the smart device.

In one embodiment, the method further comprises: detecting whether a phone set is picked up through the RJ-11 connector and the SLIC circuitry.

In one embodiment, the PCM voice data is sent to the smart device as a voice command for controlling the smart device.

In one embodiment, the PCM voice data is sent to the smart device for a speech recognition.

In one embodiment, the PCM voice data includes an information about the push-button dialing of the phone set for a designate task executed on the smart device.

In one embodiment, the smart device is a smartphone, a tablet, or a pad.

In one embodiment, an electronic device is adapted for using voice recognition system of a smart device operated in operation system. The electronic device i comprises a communication unit and a processing unit. The communication unit is configured to receive a first voice data from a voice input unit and configured to communicate with the smart device. The processing unit is coupled to the communication unit and configured to take the first voice data as a voice command inputted to the smart device through the communication unit. The communication unit is configured to receive the reply of the iOS Siri voice recognition system in response to the voice command from the smart device.

In one embodiment, the communication unit is configured to receive a second voice data from the voice input unit, and the processing unit obtains a reply of Android operating system voice service of the electronic device by inputting the second voice data to the Android operating system voice service of the electronic device.

In one embodiment, the electronic device is an OTT, a VoIP router, a cable modem or a set top box. The voice input unit is a Bluetooth MIC. The smart device is a smart phone or a tablet.

In one embodiment, the electronic device further comprises an interface for the phone set. The interface comprises a RJ-11 connector and a SLIC circuitry configured to receive a phone voice signal from the phone set. The communication unit is configured to emulate a second voice input unit for the smart device. The processing unit is configured to process the phone voice signal to generate a PCM voice data for the smart device. The communication unit is configured to send the PCM voice data to the smart device to emulate an input action from the emulated voice input unit to the smart device. The connection is Bluetooth connection, and the emulated voice input unit is a Bluetooth MIC which performs the same function with the default MIC of the smart device.

In summary, by the method, electronic device and computer with non-volatile readable storage in the embodiments, the user can use commercial available or ordinary DTMF touch tone phone set for inputting voice to the smart device. Furthermore, without pressing any button on the phone set, such voice input may instruct the smart device to perform a voice command such as Call Jon, issued from the user or to perform speech recognition.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a bock diagram showing an electronic device adapted for a phone set and a smart device according to an embodiment;

FIG. 2 is a flow chart of inputting the voice from the phone set into the smart device by the electronic device in FIG. 1;

FIG. 3 is a function block diagram of the smart device in FIG. 1;

FIG. 4 is a flow chart of a method executed by the smart device in FIG. 3; and

FIG. 5 is a function block diagram according to another embodiment.

FIG. 6 and FIG. 7 are function block diagrams according to another embodiment such as OTT.

### DETAILED DESCRIPTION OF THE INVENTION

The embodiments of the invention will be apparent from the following detailed description, which proceeds with reference to the accompanying drawings, wherein the same references relate to the same elements.

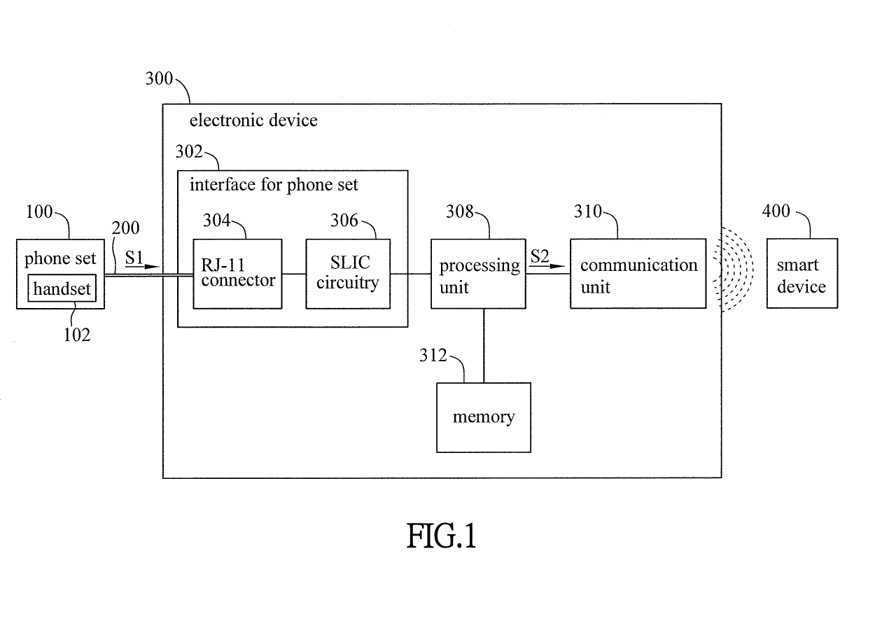

Referring to FIG. 1, FIG. 1 is a bock diagram showing an electronic device 300 adapted for a phone set 100 and a smart device 400 according to the embodiment. The electronic device 300 and the phone set 100 act as a voice input unit for the smart device 400. The smart device 400 is for example but not limited to a smartphone, a tablet, or a pad. For example, when a user speaks into the handset 102 of the phone set 100, he also speaks to the smart device 400 through the electronic device 300 and his voice becomes a voice input of the smart device 400. Furthermore, without pressing any button on the phone set 100, the user's voice may instruct the smart device 400 to perform a voice command such as “call Jon” issued from the user or to perform speech recognition.

The phone set 100 comprises a handset 102, and the phone set 100 may be a commercially available telephone set, for example a DTMF (Dual-Tone Multi-Frequency) telephone set or called touch tone phone. In the embodiment, the phone set 100 is a push-button telephone, and it comprises a plurality of buttons (e.g. button “0”, button “1”, button “2”, . . . button “*”, button “#”, etc.) for dialing a telephone number to place a call to another telephone subscriber. The phone set 100 is an analog voice input unit like a microphone and generates an analog signal (phone voice signal) like sound wave signal. In ordinary telephone use, this analog signal is sent to the telecommunication company for telephoning. Instead, to input the voice to the smart device, this analog signal is sent to the electronic device 300 when the phone set 100 is connected to the electronic device 300.

The electronic device 300 comprises an interface 302 for phone set 100, a processing unit 308, a communication unit 310 and a memory unit 312. The electronic device 300 may be implemented with/in a circuit board (e.g. PCB), an IC chip, a router, a cable modem, a set-top box. In one embodiment, the electronic device 300 may be a PCB or an IC chip disposed within the housing of the phone set 100.

The electronic device 300 is coupled to the phone set 100 by using the interface 302 for the phone set. In the embodiment, the interface for phone set 302 comprises a RJ-11 connector 304 and a SLIC (Subscriber Line Interface Card) circuitry 306. The RJ-11 connector 304 may be a jack and connects to the phone set 100 through a telephone line 200. The RJ-11 connector 312 connects the phone set 100 to the SLIC circuitry 306. The processing unit 308 can receive a phone voice signal S1 through the RJ-11 connector 304 and the SLIC circuitry 306 from the phone set 100. The SLIC circuitry 306 may be implemented with a chip or integrated into the processing unit 308. The phone set 100 sends the phone voice signal S1 to the SLIC circuitry 306 via the RJ-11 connector 304. The phone voice signal S1 is an analog signal. Then, the SLIC circuitry 306 may process this analog signal to PCM data to output the phone voice signal S1 in PCM format to the processing unit 308 under the control of the processing unit 308. For example, the SLIC circuitry 306 and the processing unit 308 convert the phone voice signal S1 into PCM voice data S2. This conversion may be implemented with PCM to output digital PCM data. The phone voice signal S1 is an analog signal generated accordingly when the user takes the handset 102 of the phone set 100 and speaks into the MIC of the handset 102.

The SLIC circuitry 306 may include a set of circuitry that will interface to the ordinary touch tone phone for the purpose of converting analog voice wave to digital PCM data. The SLIC circuitry 306 does not need to interface to PSTN telephone system or any telecom company.

In addition, with DTMF, each pressed button of the phone set 100 causes the SLIC circuitry 306 to generate two tones of specific frequencies when the user presses a button of the phone set 100. DTMF tones or push buttons signals are detected and converted by the SLIC circuitry 306 under the control of the processing unit 308. The SLIC circuitry 306, which interfaces and works with the processing unit 308, controls, detects and converts DTMF phone set signals to digital data.

In one embodiment, the processing unit 308 may comprises one or more than one controller, processor or core coupled to the interface 302 for phone set, the communication unit 310 and the memory unit 312. The communication unit 310 is configured to establish a wireless connection with the smart device 400 for example based on Bluetooth protocol or other protocol.

Moreover, the memory unit 312 can store one or more than one instruction or program which can be accesses and/or executed by the processing unit 308. For example, the memory unit 312 may be non-volatile readable storage medium such as ROM, flash memory, FPGA (Field-Programmable Gate Array) or other type memory.

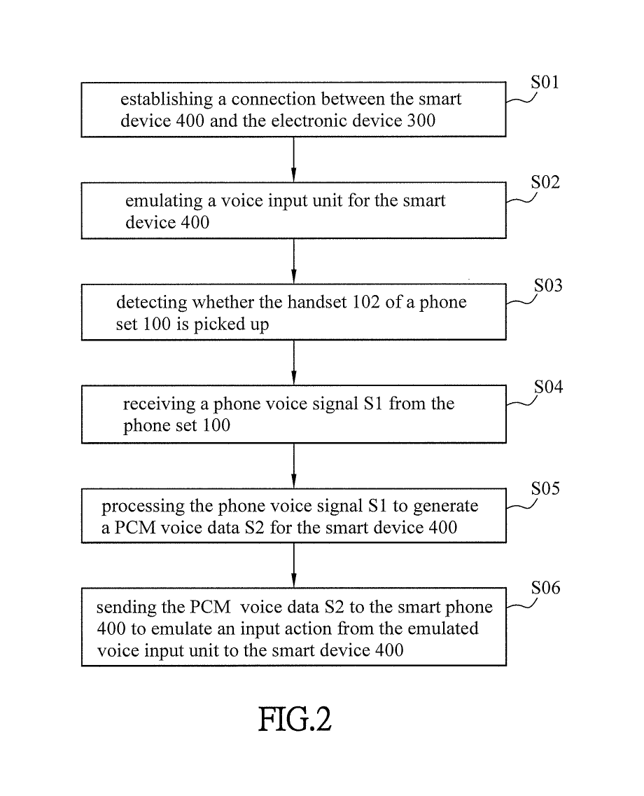

Referring to FIG. 1 and FIG. 2, FIG. 2 is a flow chart of inputting the voice from the phone set 100 into the smart device 400. The method in FIG. 2 comprises step S01 to step S06.

Step S01: establishing a connection between the smart device 400 and the electronic device 300 for example by the communication unit 310 wherein the connection may be Bluetooth connection; step S02: emulating a voice input unit for the smart device 400 for example by the communication unit 310 or in simple terms telling the smart phone that our device is a voice input device; step S03: detecting whether the handset 102 of a phone set 100 is picked up through the RJ-11 connector 304 and the SLIC circuitry 306 by the processing unit 308; step S04: receiving a phone voice signal S1 from the phone set 100 for example through the RJ-11 connector 304 and the SLIC circuitry 306; step S05: processing the phone voice signal S1 to generate a PCM voice data S2 for the smart device 400 for example by the processing unit 32; and step S06: sending the PCM voice data S2 to the smart device 400 to emulate an input action from the emulated voice input unit to the smart device 400 for example by the communication unit 310.

For example, in step S01 and step S02, the communication unit 310 establishes Bluetooth connection with the smart device 400 by using Bluetooth module. The communication unit 310 sends descriptions related to the electronic device 300 based on Bluetooth protocol to the smart device 400. This description is related to for example device ID, device type, etc. In the electronic device 300, the content of the default description indicates “voice input unit” so the electronic device 300 can emulate the voice input unit for the smart device 400. Thus, the smart device 400 regards the electronic device 300 as a Bluetooth MIC which has the same function and operating rules with the default MIC of the smart device 400.

In step S03, the processing unit 308 detects whether the handset 102 of the phone set 100 is picked up through the interface 302 for phone set. For example, if the handset 102 of the phone set 100 is not picked up, the phone set 100 does not generate any signal to the SLIC circuitry 306; if the handset 102 of the phone set 100 is picked up, the phone set 100 generates a signal (for example just a voltage or a current) to the SLIC circuitry 306, and then this signal triggers the processing unit 308. The subsequent steps continue if the processing unit 308 finds that the handset 102 is picked up.

In step S04, after finding that the handset 102 is picked up, the processing unit 308 receives the phone voice signal S1 from the phone set 100 through the RJ-11 connector 304 and the SLIC circuitry 306.

In step S05, the processing unit 308 processes the phone voice signal S1 outputted from the SLIC circuitry 306 to generate a PCM voice data S2 for the smart device 400. The processing includes converting an analog signal (the phone voice signal S1) into a digital signal (the PCM voice data S2), for example, by PCM (Pulse-Code Modulation). Thus, the phone voice signal S1 in analog is converted into the PCM voice data S2 in digital by the SLIC circuitry 306 and the processing unit 308. In addition, the SLIC circuitry 306 can detect which button of the phone set is pressed, and then can convert the pressed button into digital code emulating the user pressing a keyboard.

In step S06, the electronic device 300 has emulated the voice input unit for the smart device 400. The communication unit 310 sends the PCM voice data S2 to the smart device 400 through established connection (for example Bluetooth connection) to emulate an input action from the emulated voice input unit to the smart device 400.

In addition, the memory unit 312 may store one or more programs, the one or more programs comprises instructions, which when executed by the processing unit 308 cause the electronic device 300 to perform the previous method.

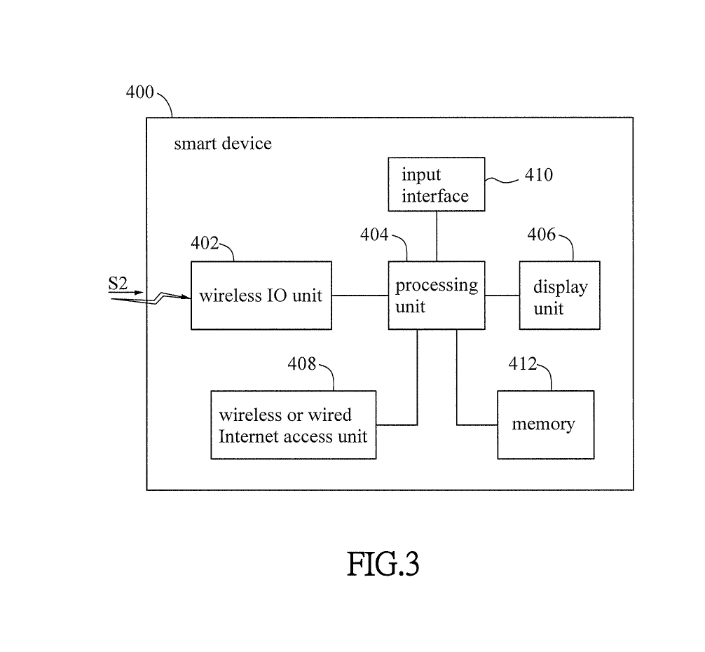

Referring to FIG. 3, FIG. 3 is a function block diagram of the smart device 400 in FIG. 1.

The smart device 400 may be a mobile phone. Generally, the smart device 400 comprises a wireless IO unit 402, a processing unit 404, a display unit 406, a wireless or wired Internet access unit 408, an input interface 410 and a memory 412.

The wireless IO unit 402 is coupled to the processing unit 404, and it may be a Bluetooth unit. The processing unit 404 may comprise one or more than one controller, processor, or core coupled to the wireless IO unit 402, the display unit 406, the wireless or wired Internet access unit 408, the input interface 410 and the memory 412. The display unit 406 may comprise a display panel, a monitor or a HDMI cable to television. The wireless or wired Internet access unit 408 may comprise a WIFI module, 3G module, a 4G module, a LTE module, a LAN module etc.

The input interface 410 may comprise a mouse, a remote control or a touch panel to receive a touch input from the user. In other embodiments, the input interface 410 may also comprise at least one physical button in addition to the touch panel. Besides, the input interface 410 and the display unit 406 may be integrated into a touch display panel.

The memory unit 412 stores operation system (e.g. iOS or Android) of the smart device 400 and at least one application program. The memory unit 412 also stores one or more than one instruction or program which can be accesses and/or executed by the processing unit 404. The memory unit 412 may comprise non-volatile readable storage medium such as ROM, flash memory, FPGA (Field-Programmable Gate Array) or other type memory.

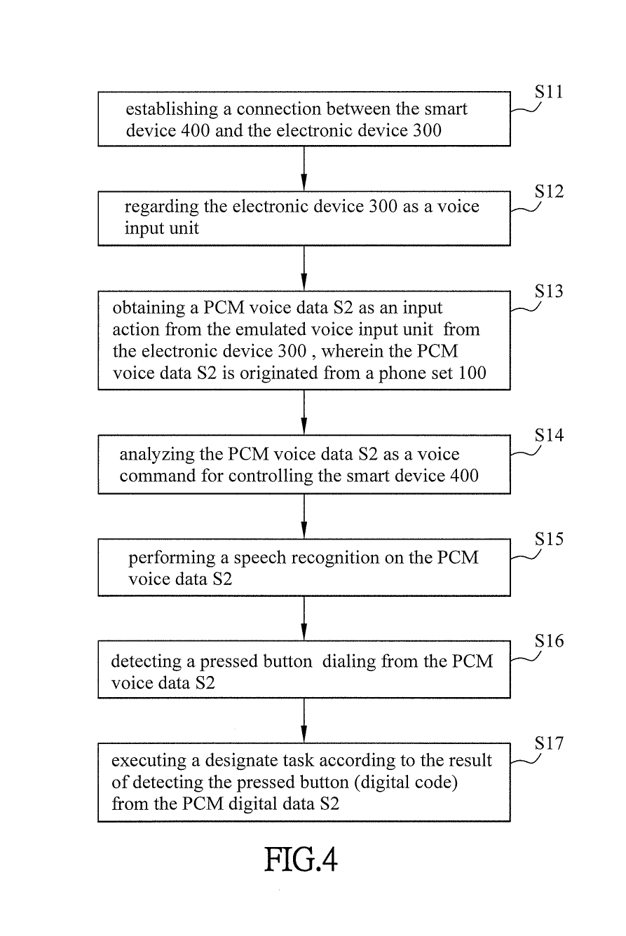

Referring to FIG. 3 and FIG. 4, the method executed by the smart device 400 in FIG. 3 comprises step S11 to step S17.

Step S11: establishing a connection between the smart device 400 and the electronic device 300; step S12: regarding the electronic device 300 as a voice input unit; step S13: obtaining a PCM voice data S2 as an input action from the emulated voice input unit (the electronic device 300) wherein the PCM voice data S2 is originated from the phone set 100; step S14: analyzing the PCM voice data S2 as a voice command for controlling the smart device 400; step S15: performing a speech recognition on the PCM voice data S2; step S16: detecting a pressed button from the PCM voice data S2; step S17: executing a designate task according to the result of detecting the pressed button (digital code) from the PCM voice data S2.

In step S11 and step S12, these steps relate to the previous step S01 and step S02. For example, after the smart device 400 has established Bluetooth connection with the electronic device 300 and knows the description of Bluetooth device, the smart device 400 regards the electronic device 300 as a voice input unit for the smart device 400. Thus, the smart device 400 regards the electronic device 300 as a Bluetooth MIC which has the same function and operating rules with the default MIC of the smart device 400.

In step S13, this step is related to the previous step S06. Since the electronic device 300 is regarded as the voice input unit by the smart device 400, the smart device 400 receives the PCM voice data S2 through the established connection (for example Bluetooth connection) as an input action from the emulated voice input unit. After receiving the PCM voice data S2, the smart device 400 may selectively perform at least one of step S14 to step S16.

After receiving the PCM voice data S2 from the communication unit 310, the smart device 400 may analyzing the PCM voice data S2 or performing a speech recognition on the PCM voice data S2. For example, in step S14, after analyzing PCM voice data S2 which is taken as a voice command, a task command for a designate task is generated according to the PCM voice data S2. For example, if the user takes the handset 102 of the phone set 100 and speaks “call Mary”, the PCM voice data S2 as a voice command is sent to the smart device 400 by the communication unit 310, and then received by the wireless IO unit 402 of the smart device 400. After the processing unit 404 analyzes the PCM voice data S2, the smart device 400 dials the telephone number for “Mary” according to the PCM voice data S2 (voice command) and establishes telephone connection with “Mary” through the wireless or wired Internet access unit 408. Besides, the voice command may control elements/functions of the smart device 400, for example, turn on/off the display unit 406.

Besides, in step S15, the content of the PCM voice data S2 may be translated into text by speech recognition, and this text may be automatically input to a search engine to search relevant information.

In step S16 and step S17, because the phone set 100 generates different DTMF signals while different buttons are pressed, the SLIC circuitry 306 can detect which button of the phone set 100 is pressed and can convert the pressed button into digital code emulating the user pressing a keyboard. The PCM voice data S2 received by the smart device 400 also contains the information related to at least one button of the phone set 100. This information can be applied for the smart device 400 to execute a designate task. For example, if the user presses the numeral button “1” of the phone set 100, the phone voice signal S1 containing the DTMF signal of button “1” is processed by the processing unit 32 and then send to the smart device 400. After receiving and detecting the DTMF signal of button “1”, the smart device 400 may accordingly perform a task for example automatically dialing. This hotkey function is convenient for the older to use.

In addition, the result of the speech recognition or the designate task may includes speech or audio. The speech or audio may be sent from the smart device 400 through the electronic device 300 and the telephone line 200 to the phone set 100. Thus, the user can use the phone set 100 to hear the result.

In addition, the memory unit 412 may store one or more programs, the one or more programs comprises instructions, which when executed by the processing unit 404 cause the smart device 400 to perform the previous method.

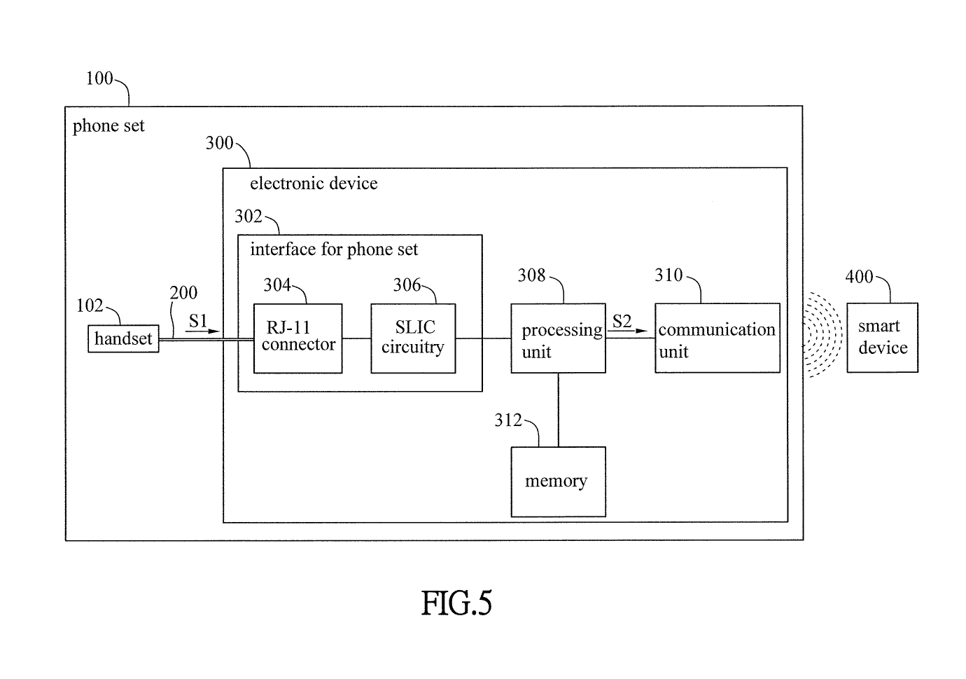

Referring to FIG. 5, FIG. 5 is a function block diagram according to another embodiment. The difference from FIG. 1 is that the electronic device 300 is disposed inside the phone set 100 or integrated with the phone set 100. For example, the electronic device 300 is a circuit board or an IC chip, so it can be disposed inside the case of the phone set 100.

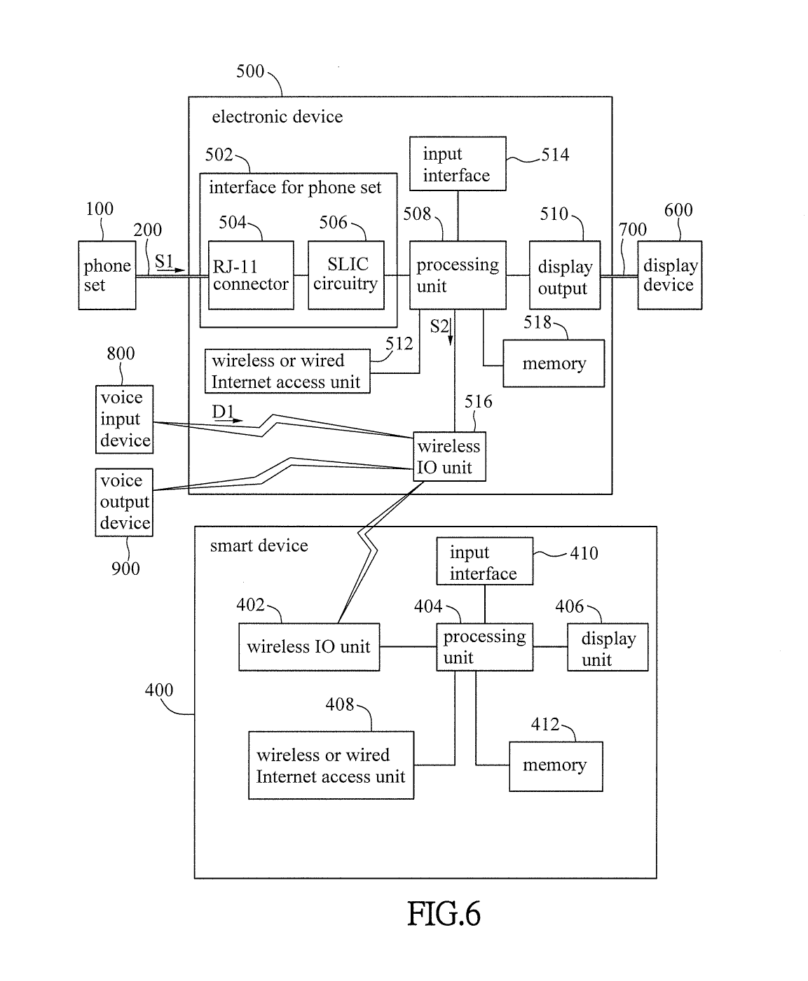

Referring to FIG. 6, FIG. 6 is a function block diagram according to another embodiment. The difference between FIG. 1 and FIG. 6 is that the electronic device 500 integrates some function of the smart device. The electronic device 500 comprises an interface 502 for phone set 100, a processing unit 508, a display output 510, a wireless or wired Internet access unit 512, an input interface 514, a wireless IO unit 516, and a memory 518. The interface 502 for phone set 100 comprises a RJ-11 connector 504 and a SLIC circuitry 506. The display output 510 may be a display port connecting to the display device 600 through a display cable 700. The display port may be a HDMI port, the display cable 700 may be a HDMI cable, and the display device 600 is for example but not limited to a TV, or a monitor. The wireless IO unit 516 is a communication unit which can communicate with other devices through a wireless connection.

In the smart device 400, the memory 412 stores programs, software and data for example: instructions and data of iOS operating system, instructions and data of iOS Siri voice recognition system, and user data. These instructions is executed by the processing unit 404 and the data are executed by the processing unit 404. The smart device 400 is operated in iOS operating system, and provides iOS Sin voice recognition system.

The memory 518 stores programs, software and data for example: instructions and data of Android operating system, instructions, data of Android operating system voice service, and user data. The memory 518 also stores software or computer programs to invoke, make use of API (Application Programming Interface) and services provided by Apple iOS and Android Google voice. These instructions is executed by the processing unit 508 and the data are executed by the processing unit 508. The electronic device 500 is operated in Android operating system and can use the iOS Siri voice recognition system of the smart device 400. The wireless IO unit 516 is configured to receive a first voice data D1 from a voice input unit 800 and configured to communicate with the smart device 400. The processing unit 508 is coupled to the wireless IO unit 516 and configured to take the first voice data D1 as a voice command inputted to the smart device 400 through the wireless IO unit 516. The wireless IO unit 516 is configured to receive the reply of the iOS Siri voice recognition system in response to the voice command from the smart device 400.

In addition, the processing unit 508 obtains the reply of the iOS Siri voice recognition system and sends the content of the reply to the display device 600 through the display output 510. Thus, the content of the reply is shown on the display device 600. Furthermore, the processing unit 508 obtains the reply of the iOS Siri voice recognition system and sends the speech or audio of the reply to a voice output device 900 through the wireless IO unit 516. Thus, the speech or audio of the reply is played on the voice output device 900.

In the embodiment, the electronic device 500 is an OTT, a VoIP router, a cable modem or a set top box. The voice input unit 800 is a Bluetooth MIC. The voice output device 900 is a Bluetooth earphone or speaker. The smart device 400 is a smart phone or a tablet. The voice input unit 800 and the voice output device 900 may be integrated as a headset.

For example, the user can speak to the voice input unit 800, then he can say “call Jon” which is a voice command for the smart device 400. Then, the smart device 400 executes this voice command to dial a phone for John. The user data for example the phonebook is not necessary stored in the electronic device 300, and the user data is still stored in the smart device 400.

The interface 502 for the phone set 100 is configured to receive a phone voice signal S1 from the phone set 100. The wireless IO unit 516 is configured to emulate a voice input unit for the smart device 400. The processing unit 508 is configured to process the phone voice signal to generate a PCM voice data S2 for the smart device 400. The wireless IO unit 516 is configured to send the PCM voice data S2 to the smart device 400 to emulate a voice input of the smart device 400. The connection is Bluetooth connection, and the emulated voice input unit is a Bluetooth MIC which performs the same function with the default MIC of the smart device 400. The processing unit 508 can take the PCM voice data S2 as a voice command inputted to the smart device 400 through the wireless IO unit 516. The wireless IO unit 516 is configured to receive the reply of the iOS Siri voice recognition system in response to the voice command from the smart device 400. The content of the reply for the PCM voice data can be sent to the display device 600 to show. Moreover, the speech or audio of the reply can be sent to the phone set 100 to play.

For example, the user can speak to the phone set 502, then he can say “call Jon” which is a voice command for the smart device 400. Then, the smart device 400 executes this voice command to dial a phone for John.

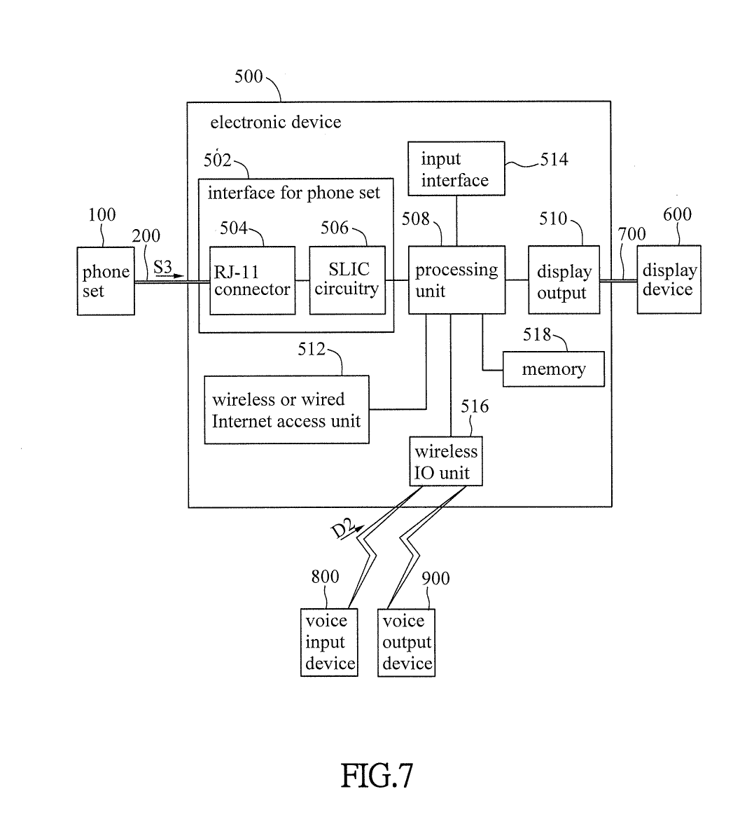

Referring to FIG. 7, FIG. 7 is a function block diagram. In FIG. 7, the electronic device 500 does not operate with the smart device 400. The wireless IO unit 516 is configured to receive a second voice data D2 from the voice input unit 800, and the processing unit 508 obtains a reply of Android operating system voice service of the electronic device 500 by inputting the second voice data D2 to the Android operating system voice service of the electronic device 500. The content of the reply for the second voice data can be sent to the display device 600 to show. Moreover, the speech or audio of the reply can be sent to the voice output device 900 to play.

In addition, the interface 502 for the phone set 100 receives a phone voice signal S3 from the phone set 502. The processing unit 508 is configured to process the phone voice signal to generate a PCM voice data. The processing unit 508 obtains a reply of the Android operating system voice service of the electronic device 500 by inputting the PCM voice data to the Android operating system voice service of the electronic device 500. The content of the reply for the PCM voice data can be sent to the display device 600 to show. Moreover, the speech or audio of the reply can be sent to the phone set 100 to play.

For example, the user can speak to the voice input unit 800 or phone set 100, then he can say “arrival time for flight CX590” or “what is the weather today” which is a voice command for the electronic device 300. Then, the electronic device 300 performs a search accordingly and replies a result in sound or voice. The user can hear the result.

In summary, by the method, electronic device and computer with non-volatile readable storage in the embodiments, the user can use commercial available or ordinary phone set for inputting voice to the smart device. Furthermore, without pressing any button on the phone set, such voice input may instruct the smart device to perform a voice command issued from the user or to perform speech recognition.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of inputting the voice of a phone set into a smart device, comprising:
emulating a voice input unit for the smart device by an electronic device;
receiving a phone voice signal from the phone set through a RJ-11 connector and a SLIC circuitry of the electronic device;
processing the phone voice signal to generate a PCM voice data for the smart device by a processing unit of the electronic device; and
sending the PCM voice data to the smart device to emulate an input action from the emulated voice input unit to the smart device by a communication unit of the electronic device.

2. The method of claim 1, further comprising:
establishing a connection between the smart device and the electronic device by the communication unit, wherein the connection is Bluetooth connection, and the emulated voice input unit is a Bluetooth MIC which performs the same function with the default MIC of the smart device.

3. The method of claim 1, further comprising:
detecting whether a phone set is picked up through the RJ-11 connector and the SLIC circuitry by the processing unit.

4. The method of claim 1, further comprising:
analyzing the PCM voice data as a voice command for controlling the smart device by the smart device; and
performing a speech recognition on the PCM voice data by the smart device.

5. The method of claim 1, further comprising:
detecting which button of the phone set is pressed;
converting the pressed button into digital code emulating the user pressing a keyboard; and
executing a designate task according to the result of detecting the pressed button (digital code).

6. The method of claim 1, wherein the phone voice signal is converted from analog to digital by the SLIC circuitry and the processing unit to generate the PCM voice data, and the PCM voice data is sent to the smart device without additional voice analyzation and voice recognition performed by the processing unit.

7. An electronic device adapted for a phone set and a smart device, comprising:
a communication unit configured to emulate a voice input unit for the smart device;
an interface for the phone set, comprising a RJ-11 connector and a SLIC circuitry configured to receive a phone voice signal from the phone set; and
a processing unit configured to process the phone voice signal to generate a PCM voice data for the smart device, wherein the communication unit is configured to send the PCM voice data to the smart device to emulate an input action from the emulated voice input unit to the smart device.

8. The electronic device of claim 7, wherein the electronic device is a PCB, a chip, VoIP router, a cable modem or a set top box, wherein the communication unit is configured to establish a connection between the smart device and the electronic device, the connection is Bluetooth connection, and the emulated voice input unit is a Bluetooth MIC which performs the same function with the default MIC of the smart device.

9. The electronic device of claim 7, wherein the processing unit is configured to detect whether a phone set is picked up through the RJ-11 connector and the SLIC circuitry.

10. The electronic device of claim 7, wherein the phone voice signal is converted from analog to digital by the SLIC circuitry and the processing unit to generate the PCM voice data, and the PCM voice data is sent to the smart device without additional voice analyzation and voice recognition performed by the processing unit.

11. The electronic device of claim 7, wherein the PCM voice data is sent to the smart device as a voice command for controlling the smart device, and the PCM voice data is sent to the smart device for a speech recognition.

12. The electronic device of claim 7, wherein the PCM voice data includes an information about the push-button dialing of the phone set for a designate task executed on the smart device.

13. A computer with non-volatile readable storage medium storing one or more programs, the one or more programs comprising instructions, which when executed by one or more processors of the computer, cause the computer to perform a method for a phone set and a smart device comprising:
emulating a voice input unit for the smart device;
receiving a phone voice signal from the phone set through a RJ-11 connector and a SLIC circuitry;
processing the phone voice signal to generate a PCM voice data for the smart device; and
sending the PCM voice data to the smart device to emulate an input action from the emulated voice input unit to the smart device.

14. The computer of claim 13, wherein the method further comprises:
establishing a connection between the smart device and the electronic device, wherein the connection is Bluetooth connection, and the emulated voice input unit is a Bluetooth MIC which performs the same function with the default MIC of the smart device.

15. The computer of claim 13, wherein the method further comprises:
detecting whether a phone set is picked up through the RJ-11 connector and the SLIC circuitry.

16. The computer of claim 13, wherein the PCM voice data is sent to the smart device as a voice command for controlling the smart device, and the PCM voice data is sent to the smart device for a speech recognition.

17. The computer of claim 13, wherein the PCM voice data includes an information about the push-button dialing of the phone set for a designate task executed on the smart device.

18. An electronic device for using voice recognition system of a smart device operated in operation system, comprising:
a communication unit configured to receive a first voice data from a voice input unit and configured to communicate with the smart device;
a processing unit coupled to the communication unit and configured to take the first voice data as a voice command inputted to the smart device through the communication unit,
wherein the communication unit is configured to receive the reply of the voice recognition system in response to the voice command from the smart device.

19. The electronic device of claim 18, wherein the communication unit is configured to receive a second voice data from the voice input unit, and the processing unit obtains a reply of operating system voice service of the electronic device by inputting the second voice data to the operating system voice service of the electronic device.

20. The electronic device of claim 19, wherein the electronic device is an OTT, a VoIP router, a cable modem or a set top box, wherein the voice input unit is a Bluetooth MIC, wherein the smart device is a smart phone or a tablet, wherein the electronic device further comprises:
an interface for the phone set, comprising a RJ-11 connector and a SLIC circuitry configured to receive a phone voice signal from the phone set,
wherein the communication unit is configured to emulate a second voice input unit for the smart device,
wherein the processing unit is configured to process the phone voice signal to generate a PCM voice data for the smart device,
wherein the communication unit is configured to send the PCM voice data to the smart device to emulate an input action from the emulated voice input unit to the smart device,
wherein the connection is Bluetooth connection, and the emulated voice input unit is a Bluetooth MIC which performs the same function with the default MIC of the smart device.
